(19) United States
(12) Patent Application Publication
(10) Pub. No.: US 2023/0298502 A1
(43) Pub. Date: Sep. 21, 2023

(54) DISPLAY DEVICE

(71) Applicant: Samsung Display Co., Ltd., Yongin-si (KR)

(72) Inventors: Jae Hoon LEE, Yongin-si (KR); Byoung Kwan AN, Yongin-si (KR)

(21) Appl. No.: 17/960,868

(22) Filed: Oct. 6, 2022

(30) Foreign Application Priority Data
Mar. 16, 2022 (KR) 10-2022-0032916

(51) Int. Cl. G09G 3/20; G09G 3/3233; G09G 3/3291

(52) U.S. Cl. CPC G09G 3/2007; G09G 3/3233; G09G 3/3291; G09G 2300/0842; G09G 2300/0819; G09G 2320/043; G09G 2360/16; G09G 2320/0257

(57) ABSTRACT

A display device includes a pixel, a deterioration compensator, and a data driver. The pixel includes a light emitting element. The deterioration compensator records a deterioration amount of the pixel in response to an input grayscale, determines a change amount of a driving voltage of the light emitting element based on the deterioration amount and the input grayscale, and generates adjusted data by calculating an adjustment amount based on the change amount of the driving voltage of the light emitting element. The data driver supplies a data voltage corresponding to the adjusted data to the pixel. The change amount of the driving voltage of the light emitting element varies according to the input grayscale.

### CROSS-REFERENCE TO RELATED APPLICATION

The application claims priority to and the benefit of Korean Patent Application No. 10-2022-0032916 filed on Mar. 16, 2022; the Korean Patent Application is incorporated by reference.

### BACKGROUND

### Field

The technical field relates to a display device.

### Related Art

A display device may display images in response to input signals. Modern display devices include liquid crystal display devices, organic light emitting display devices, and the like.

An organic light emitting display device may include pixels for displaying images. Each of the pixels may include a light emitting element and a transistor for driving the light emitting element. The transistor may control the amount of current flowing through the light emitting element, so that the pixel displays the grayscale for a portion of an image.

As the usage time of a display device increases, the light emitting elements of the display device may deteriorate. As a result, the performance of the display device may become unsatisfactory.

### SUMMARY

Embodiments may be related to a display device capable of detecting and compensating for deterioration of a light emitting element.

A display device according to an embodiment may include the following elements: pixels displaying an image and each including a light emitting element; a deterioration compensator accumulating a deterioration amount of the pixels in response to an input grayscale, extracting a change amount of a driving voltage of the light emitting element of at least one of the pixels with respect to the deterioration amount, and generating compensation data by calculating a compensation amount based on the change amount of the driving voltage of the light emitting element; and a data driver supplying a data voltage corresponding to the compensation data to the pixels, and the change amount of the driving voltage of the light emitting element may vary according to the input grayscale.

The change amount of the driving voltage of the light emitting element may increase as the input grayscale increases.

The change amount of the driving voltage of the light emitting element may increase as the deterioration amount increases.

The at least one of the pixels may include the following elements: a first transistor including a first electrode connected to a first driving voltage through a first node, a second electrode connected to a connected node, and a gate electrode connected to a second node; a second transistor including a first electrode connected to a data line, a second electrode connected to the second node, and a gate electrode connected to a first gate line; a third transistor including a first electrode connected to a reference voltage, a second electrode connected to the second node, and a gate electrode connected to a second gate line; and a storage capacitor including one electrode connected to the second node and the other electrode connected to the connected node, and the light emitting element may include a first electrode connected to the connected node and a second electrode connected to a second driving voltage different from the first driving voltage.

The change amount of the driving voltage of the light emitting element may be a difference between an initial voltage of the connected node and a voltage of the connected node according to the deterioration amount.

The deterioration compensator may drive the first transistor in a linear mode and extract the change amount of the driving voltage of the light emitting element corresponding to a current value of the light emitting element output as the first driving voltage is changed.

The first transistor may output the first driving voltage to the connected node when driven in the linear mode.

The at least one of the pixels further may include the following elements: a fourth transistor including a first electrode connected to the connected node, a second electrode connected to an initialization voltage, and a gate electrode connected to a third gate line; and a fifth transistor including a first electrode connected to the first driving voltage, a second electrode connected to the first node, and a gate electrode connected to an emission control line.

The deterioration compensator may drive the first transistor in a linear mode and extract the change amount of the driving voltage of the light emitting element corresponding to a current value of the light emitting element output as the first driving voltage is changed.

The first transistor may output the first driving voltage to the connected node when driven in the linear mode.

The display device may further include a memory including a lookup table in which the change amount of the driving voltage of the light emitting element with respect to the input grayscale is stored for each deterioration amount.

The deterioration compensator may receive information stored in the lookup table from the memory and calculate the compensation amount based on the change amount of the driving voltage of the light emitting element.

The deterioration accumulator may store the deterioration amount having a larger value as a temperature increases and a larger value as a luminance of the image increases.

A display device according to an embodiment may include the following elements: pixels displaying an image and each including a light emitting element; a deterioration compensator accumulating a deterioration amount of the pixels in response to an input grayscale, extracting a change amount of a driving voltage of the light emitting element of at least one of the pixels with respect to the deterioration amount, and generating compensation data by calculating a compensation amount based on the change amount of the driving voltage of the light emitting element; and a data driver supplying a data voltage corresponding to the compensation data to the pixels. The deterioration compensator may sense the driving voltage of the light emitting element of at least one of the pixels to extract the change amount of the driving voltage of the light emitting element, and the change amount of the driving voltage of the light emitting element may vary according to the input grayscale.

The change amount of the driving voltage of the light emitting element may increase as the input grayscale increases.

The change amount of the driving voltage of the light emitting element may increase as the deterioration amount increases.

The at least one of the pixels may include the following elements: a first transistor including a first electrode connected to a first driving voltage, a second electrode connected to a connected node, and a gate electrode connected to a first node; a second transistor including a first electrode connected to a data line, a second electrode connected to the first node, and a gate electrode connected to a gate line; a third transistor including a first electrode connected to a sensing line, a second electrode connected to the second electrode of the first transistor, and a gate electrode connected to a control line; and a storage capacitor including one electrode connected to the first node and the other electrode connected to the connected node, and the light emitting element may include a first electrode connected to the connected node and a second electrode connected to a second driving voltage different from the first driving voltage.

The driving voltage of the light emitting element may be a voltage of the connected node, and the deterioration compensator may sense the voltage of the connected node.

The display device may further include a memory including a lookup table in which the change amount of the driving voltage of the light emitting element with respect to the input grayscale is stored for each deterioration amount.

The memory may receive the change amount of the driving voltage of the light emitting element from the deterioration compensator.

An embodiment may be related to a display device. The display device may include a pixel, a deterioration compensator, and a data driver. The pixel may include a light emitting element. The deterioration compensator may record a deterioration amount of the pixel in response to an input grayscale, may determine a change amount of a driving voltage of the light emitting element based on the deterioration amount and the input grayscale, and may generate adjusted data by calculating an adjustment amount based on the change amount of the driving voltage of the light emitting element. The data driver may supply a data voltage corresponding to the adjusted data to the pixel.

The change amount of the driving voltage of the light emitting element may increase as the input grayscale increases.

The change amount of the driving voltage of the light emitting element may increase as the deterioration amount increases.

The display device may include a data line, a first gate line, and a second gate line. The pixel may include the following elements: a first node; a second node; a connected node; a first transistor including a first electrode receiving a first driving voltage through the first node, a second electrode electrically connected to the connected node, and a gate electrode electrically connected to the second node; a second transistor including a first electrode electrically connected to the data line, a second electrode electrically connected to the second node, and a gate electrode electrically connected to the first gate line; a third transistor including a first electrode receiving a reference voltage, a second electrode electrically connected to the second node, and a gate electrode electrically connected to the second gate line; and a storage capacitor including a first electrode electrically connected to the second node and including a second electrode electrically connected to the connected node. The light emitting element may include a first electrode electrically connected to the connected node and may include a second electrode receiving a second driving voltage different from the first driving voltage.

The change amount of the driving voltage of the light emitting element may be a difference between an initial voltage of the connected node and a voltage of the connected node according to the deterioration amount.

The deterioration compensator may cause the first transistor to operate in a linear mode and may determine the change amount of the driving voltage of the light emitting element based on a current value of the light emitting element as the first driving voltage is changed.

The first transistor may output the first driving voltage to the connected node when operating in the linear mode.

The display device may include a third gate line and an emission control line. The pixel may include the following elements: a fourth transistor including a first electrode electrically connected to the connected node, a second electrode receiving an initialization voltage, and a gate electrode electrically connected to the third gate line; and a fifth transistor including a first electrode receiving the first driving voltage, a second electrode electrically connected to the first node, and a gate electrode electrically connected to the emission control line.

The deterioration compensator may cause the first transistor to operate in a linear mode and may determine the change amount of the driving voltage of the light emitting element based on a current value of the light emitting element as the first driving voltage is changed.

The first transistor may output the first driving voltage to the connected node when operating in the linear mode.

The display device may include a memory including a lookup table. The lookup table may specify values of the change amount of the driving voltage of the light emitting element corresponding to values of the input grayscale and values of the deterioration amount.

The deterioration compensator may receive information specified in the lookup table from the memory and may calculate the adjustment amount based on the change amount of the driving voltage of the light emitting element.

The deterioration compensator may store an increased value of the deterioration amount as at least one of a temperature of the display device and a luminance of an image displayed by the display device increases.

An embodiment may be related to a display device. The display device may include a pixel, a deterioration compensator, and a data driver. The pixel may include a light emitting element. The deterioration compensator may record a deterioration amount of the pixel in response to an input grayscale, may determine a change amount of a driving voltage of the light emitting element based on the deterioration amount and the input grayscale, and may generate adjusted data by calculating an adjustment amount based on the change amount of the driving voltage of the light emitting element. The data driver may supply a data voltage corresponding to the adjusted data to the pixels. The deterioration compensator may sense the driving voltage of the light emitting element to determine the change amount of the driving voltage of the light emitting element.

The change amount of the driving voltage of the light emitting element may increase as the input grayscale increases.

The change amount of the driving voltage of the light emitting element may increase as the deterioration amount increases.

The display device may include a data line, a gate line, a sensing line, and a control line. The pixel may include the following elements: a first node; a connected node; a first transistor including a first electrode receiving a first driving voltage, a second electrode electrically connected to the connected node, and a gate electrode electrically connected to the first node; a second transistor including a first electrode electrically connected to the data line, a second electrode electrically connected to the first node, and a gate electrode electrically connected to the gate line; a third transistor including a first electrode electrically connected to the sensing line, a second electrode electrically connected to the connected node, and a gate electrode electrically connected to the control line; and a storage capacitor including a first electrode electrically connected to the first node and including a second electrode electrically connected to the connected node. The light emitting element may include a first electrode electrically connected to the connected node and may include a second electrode receiving a second driving voltage different from the first driving voltage.

The driving voltage of the light emitting element may be a voltage of the connected node. The deterioration compensator may sense the voltage of the connected node.

The display device may include a memory including a lookup table. The lookup table may specify values of the change amount of the driving voltage of the light emitting element corresponding to values of the input grayscale and values of the deterioration amount.

The memory may receive the change amount of the driving voltage of the light emitting element from the deterioration compensator.

### BRIEF DESCRIPTION OF THE DRAWINGS

FIG. 1 is a block diagram illustrating a configuration of a display device according to an embodiment.

FIG. 2 is a circuit diagram illustrating a pixel included in FIG. 1 according to an embodiment.

FIG. 3 is a graph illustrating a current reduction ratio with respect to usage time of the display device according to an input grayscale according to an embodiment.

FIG. 4 is a block diagram illustrating a configuration of a deterioration compensator according to an embodiment.

FIG. 5A is a graph illustrating a luminance acceleration coefficient according to an embodiment.

FIG. 5B is a graph illustrating a temperature acceleration coefficient according to an embodiment.

FIG. 6 is a graph illustrating a change amount of a driving voltage of a light emitting element with respect to a deterioration amount according to the input grayscale in the display device according to an embodiment.

FIG. 7 and FIG. 8 are diagrams illustrating lookup tables stored in a memory according to one or more embodiments.

FIG. 9 is a graph illustrating a current value flowing through the light emitting element with respect to a first driving voltage in the display device according to an embodiment.

FIG. 10 is a graph illustrating a relationship of a compensation amount with respect to the change amount of the driving voltage of the light emitting element in the display device according to an embodiment.

FIG. 11 is a block diagram illustrating a configuration of a display device according to an embodiment.

FIG. 12 is a block diagram illustrating a configuration of a display device according to an embodiment.

FIG. 13 is a circuit diagram illustrating a pixel included in FIG. 12 according to an embodiment.

FIG. 14 is a block diagram illustrating a configuration of a deterioration compensator according to an embodiment.

### DETAILED DESCRIPTION

Examples of embodiments are described with reference to the drawings. Practical embodiments may include changes, equivalents, and substitutes to one or more features of the described embodiments.

Although the terms “first,” “second,” etc. may be used to describe various elements, these elements should not be limited by these terms. These terms are used to distinguish one element from another element. A first element may be termed a second element without departing from the scope of the teachings of embodiments. A second element may be termed a first element. The description of an element as a “first” element may not require or imply the presence of a second element or other elements. The terms “first,” “second,” etc. may be used to differentiate different categories or sets of elements. For conciseness, the terms “first,” “second,” etc. may represent “first-category (or first-set),” “second-category (or second-set),” etc., respectively.

In the disclosure, singular expressions may represent plural expressions as well, unless the context clearly indicates otherwise.

The terms “comprise”, “include”, “have”, etc. may specify the presence of the stated features and/or elements but may not preclude the presence or addition of one or more other features and/or elements.

The term “connect” may mean “directly connect” or “indirectly connect.” The term “connect” may mean “mechanically connect” and/or “electrically connect.” The term “connected” may mean “electrically connected” or “electrically connected through no intervening transistor.” The term “insulate” may mean “electrically insulate” or “electrically isolate.” The term “conductive” may mean “electrically conductive.” The term “drive” may mean “operate” or “control.” The term “compensate” may mean “adjust.” The term “compensation” may mean “adjusted” or “adjustment.” The term “extract” may mean “obtain” and/or “determine.” The term “generate” may mean “determine.” The term “accumulate” may mean “track” or “record.”

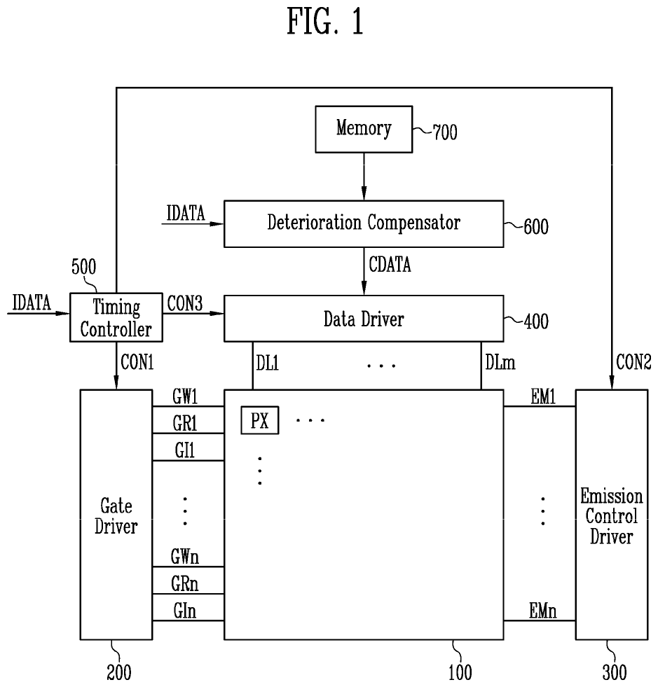

FIG. 1 is a block diagram illustrating a configuration of a display device according to an embodiment.

Referring to FIG. 1, the display device may include a pixel unit 100, a gate driver 200, an emission control driver 300, a data driver 400, a timing controller 500, a deterioration compensator 600, and a memory 700.

The display device may be/include an organic light emitting display device, an inorganic light emitting display device, or the like. The display device may be/include a flexible display device, a rollable display device, a curved display device, a transparent display device, and/or a mirror display device.

The pixel unit 100 may include pixels PX for displaying an image. The pixel unit 100 may include a pixel PX electrically connected to at least one of first gate lines GW1 to GWn, at least one of second gate lines GR1 to GRn, at least one of third gate lines GI1 to GIn, at least one of emission control lines EM1 to EMn, and at least one of data lines DL1 to DLm.

The gate driver 200 may provide a first gate signal, a second gate signal, and a third gate signal to the pixels PX of the pixel unit 100 through the first gate lines GW1 to GWn, the second gate lines GR1 to GRn, and the third gate lines GI1 to GIn, respectively. The gate driver 200 may provide the first gate signal, the second gate signal, and the third gate signal to the pixel unit 100 based on a gate control signal CONI received from the timing controller 500. The first gate lines GW1 to GWn, the second gate lines GR1 to GRn, and the third gate lines GI1 to GIn are connected to one or more gate drivers 200.

The emission control driver 300 may provide an emission control signal to the pixels PX of the pixel unit 100 through the emission control lines EM1 to EMn. The emission control driver 300 may provide the emission control signal to the pixel unit 100 based on an emission driving control signal CON2 received from the timing controller 500.

The data driver 400 may provide a data voltage to the pixels PX of the pixel unit 100 through the data lines DL1 to DLm based on compensation data CDATA (or adjusted data CDATA) received from the deterioration compensator 600 and/or a data control signal CON3 received from the timing controller 500.

The data driver 400 may include a gamma converter (not shown) that converts the compensation data CDATA provided from the deterioration compensator 600 into the data voltage. The compensation data CDATA in a grayscale domain may be converted into the data voltage in a voltage domain by the gamma converter of the data driver 400. The data voltage may be supplied to the pixels PX of the pixel unit 100.

The gamma converter may be separated from the data driver 400.

The timing controller 500 may receive input image data IDATA from an external source and may generate the gate control signal CON1, the emission driving control signal CON2, and the data control signal CON3. The timing controller 500 may control the driving of the gate driver 200, the emission control driver 300, and the data driver 400 by providing the gate control signal CON1, the emission driving control signal CON2, and the data control signal CON3 to the gate driver 200, the emission control driver 300, and the data driver 400, respectively. The input image data IDATA may include an input grayscale. The timing controller 500 may further control the driving of the deterioration compensator 600.

The deterioration compensator 600 may accumulate and/or determine a deterioration amount of the pixels PX of the pixel unit 100 in response to the input image data IDATA (or the input grayscale) and extract and/or obtain a change amount of a driving voltage of the light emitting element of each pixel PX with respect to the deterioration amount. The deterioration compensator 600 may determine and/or generate a compensation amount based on the change amount of the driving voltage of the light emitting element, and may generate the compensation data CDATA based on the compensation amount. The deterioration compensator 600 may provide the generated compensation data CDATA to the data driver 400. The change amount of the driving voltage of the light emitting element of each pixel PX may vary according to the input grayscale. The deterioration compensator 600 may generate the compensation amount of/for each pixel PX by extracting the change amount of the driving voltage of the light emitting element of each pixel PX with respect to the input grayscale, and may generate the compensation data CDATA based on the compensation amount.

The deterioration compensator 600 may drive at least one transistor constituting the pixel PX in a linear mode in order to extract the change amount of the driving voltage of the light emitting element. The driving of the deterioration compensator 600 for extracting the change amount of the driving voltage of the light emitting element, generating the compensation amount, and generating the compensation data CDATA is described with reference to FIGS. 4 to 10.

The memory 700 may include a lookup table in which the change amount of the driving voltage of the light emitting element with respect to the input grayscale is stored for each of predetermined deterioration amounts. The change amount of the driving voltage of the light emitting element with respect to the input grayscale set in the lookup table may be a value set in advance before the display device is shipped and/or sold, or may be a value newly set when the product is being used. The deterioration compensator 600 may receive the change amount of the driving voltage of the light emitting element with respect to the input grayscale for each of predetermined deterioration amounts from the memory 700, and may generate the compensation data CDATA based on the change amount of the driving voltage of the light emitting element. The deterioration compensator 600 may receive information stored in the lookup table from the memory 700, and may generate the compensation data CDATA based on the change amount of the driving voltage of the light emitting element.

The display device may detect the change amount of the driving voltage of the light emitting element that is changed as the usage time of the display device increases (or the display device deteriorates), and may compensate for the deterioration to improve image quality and/or minimize an unwanted afterimage.

FIG. 1 illustrates that the deterioration compensator 600 is separate from the timing controller 500. The deterioration compensator 600 may be included in the timing controller 500. The deterioration compensator 600 may be included in the data driver 400.

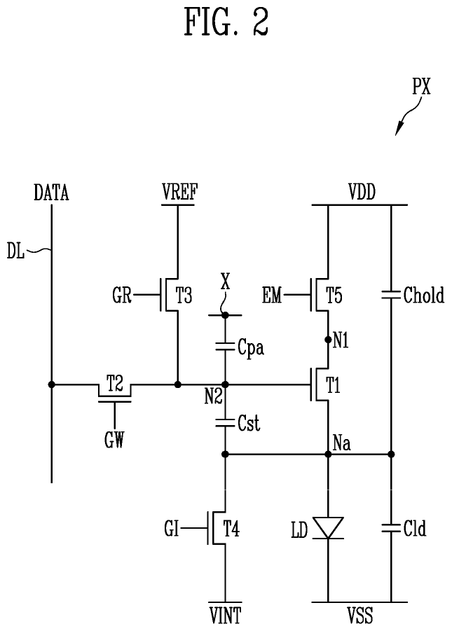

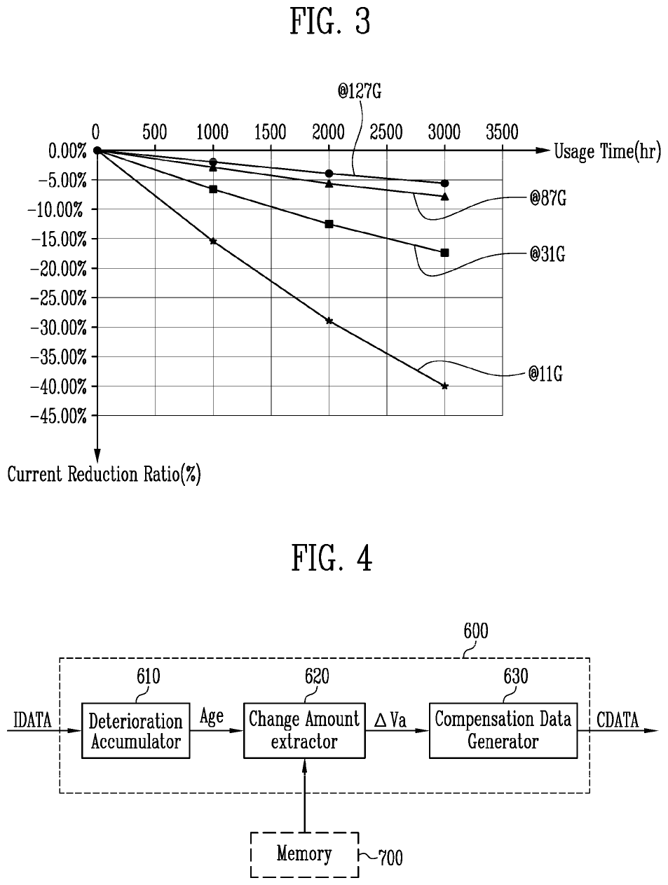

FIG. 2 is a circuit diagram illustrating a pixel included in FIG. 1 according to an embodiment. FIG. 3 is a graph illustrating a current reduction ratio with respect to usage time of the display device according to an input grayscale according to an embodiment.

Referring to FIG. 2, the pixel PX may include a first transistor T1, a second transistor T2, a third transistor T3, a fourth transistor T4, a fifth transistor T5, capacitors Cst, Cpa, Chold, and Cld, and a light emitting element LD.

The first transistor T1 (or a driving transistor) may include a first electrode connected to a first node N1 (or a first driving voltage VDD through a first node N1), a second electrode connected to a connected node Na, and a gate electrode connected to a second node N2. The first driving voltage VDD may be applied to the first node N1 through the fifth transistor T5 (or an emission control transistor). A voltage of an anode electrode of the light emitting element LD may be applied to the connected node Na. A data voltage DATA may be applied to the second node N2 through the second transistor T2.

The first transistor T1 may control the amount of current flowing from the first node N1 to the connected node Na according to a voltage applied to the second node N2. A driving mode of the first transistor T1 may be changed according to the voltage applied to the second node N2. Since a voltage of the gate electrode of the first transistor T1 corresponds to the voltage of the second node N2, according to a voltage-current characteristic of the first transistor T1, a driving current (for example, a current flowing from the first node N1 to the connected node Na) may be determined in response to a gate-source voltage applied between the gate electrode and a source electrode of the first transistor T1. When the gate-source voltage of the first transistor T1 is greater than a threshold voltage of the first transistor T1 and when a drain-source voltage of the first transistor T1 is less than a difference between the gate-source voltage and the threshold voltage, the first transistor T1 may operate in a linear region/mode. When the gate-source voltage of the first transistor T1 is greater than the threshold voltage of the first transistor T1 and when the drain-source voltage of the first transistor T1 is greater than the difference between the gate-source voltage and the threshold voltage, the first transistor T1 may operate in a saturation region/mode (or a display mode).

The display device may extract a voltage of the connected node Na according to the current flowing through the light emitting element LD by driving the first transistor T1 in the linear mode. An operation of extracting the voltage of the connected node Na is with reference to FIGS. 4 to 9. The display device may determine the degree of deterioration of the light emitting element LD based on the extracted voltage of the connected node Na, and may calculate the compensation amount according to a change amount of the voltage of the connected node Na.

The second transistor T2 may include a first electrode connected to a data line DL, a second electrode connected to the second node N2, and a gate electrode connected to a first gate line GW. The second node N2 may be connected to the gate electrode of the first transistor T1. The second transistor T2 may electrically connect the data line DL and the second node N2 when a turn-on signal (for example, a high level voltage) is applied through the first gate line GW. Accordingly, a voltage corresponding to the data voltage DATA may be applied to the gate electrode of the first transistor T1.

The third transistor T3 may include a first electrode receiving a reference voltage VREF, a second electrode connected to the second node N2, and a gate electrode connected to a second gate line GR. The third transistor T3 may electrically connect a reference voltage line supplying the reference voltage VREF to the second node N2 when the turn-on signal (for example, the high level voltage) is applied through the second gate line GR. Accordingly, the reference voltage VREF may be provided to the second node N2.

The fourth transistor T4 may include a first electrode connected to the connected node Na, a second electrode receiving an initialization voltage VINT, and a gate electrode connected to a third gate line GI. The fourth transistor T4 may electrically connect an initialization voltage line supplying the initialization voltage VINT to the connected node Na when the turn-on signal (for example, the high level voltage) is applied through the third gate line GI. Accordingly, the initialization voltage VINT may be provided to the connected node Na.

The fifth transistor T5 may include a first electrode receiving the first driving voltage VDD, a second electrode connected to the first node N1, and a gate electrode connected to an emission control line EM. The fifth transistor T5 may electrically connect a first driving voltage line supplying the first driving voltage VDD to the first node N1 when the turn-on signal (for example, the high level voltage) is applied through the emission control line EM. Accordingly, the first driving voltage VDD may be provided to the first node N1.

The display device may extract the voltage of the connected node Na according to the current flowing through the light emitting element LD by driving the first transistor T1 in the linear mode. The display device may determine the degree of deterioration of the light emitting element LD based on the extracted voltage of the connected node Na, and may calculate the compensation amount according to the change amount of the voltage of the connected node Na.

A person skilled in the art would be able to design a circuit including a P-type transistor by changing the polarity of a voltage applied to the gate electrode. A person skilled in the art would be able to design a circuit including a combination of a P-type transistor and an N-type transistor. A P-type transistor may refer to a transistor in which the amount of conducted current increases when a voltage difference between a gate electrode and a source electrode increases in a negative direction. An N-type transistor may refer to a transistor in which the amount of conducting current increases when a voltage difference between a gate electrode and a source electrode increases in a positive direction. The transistors may include one or more of a thin film transistor (TFT), a field effect transistor (FET), and a bipolar junction transistor (BJT).

The capacitors Cst, Cpa, Chold, and Cld may include a storage capacitor Cst, a gate parasitic capacitor Cpa, a hold capacitor Chold, and an emission parasitic capacitor Cld.

The storage capacitor Cst may include one electrode connected to the second node N2 and may include the other electrode connected to the connected node Na. The storage capacitor Cst may store a voltage corresponding to a voltage difference between the second node N2 and the connected node Na.

The gate parasitic capacitor Cpa may include one electrode connected to the second node N2 and may include the other electrode connected to a node X. The node X may refer to a node between elements that may be electrically connected to the gate electrode of the first transistor T1 in the display device and the gate electrode of the first transistor T1. The gate parasitic capacitor Cpa may be formed between the gate electrode of the first transistor T1 and the elements corresponding to the node X.

The hold capacitor Chold may include one electrode connected to the connected node Na and may include the other electrode receiving the first driving voltage VDD. The hold capacitor Chold may store a voltage corresponding to a voltage difference between the first driving voltage VDD and the connected node Na.

The emission parasitic capacitor Cld may include one electrode connected to the connected node Na and may include the other electrode receiving a second driving voltage VSS.

The light emitting element LD may include a first electrode (anode or cathode) connected to the connected node Na and may include a second electrode (anode or cathode) connected to the second driving voltage VSS. The light emitting element LD may generate light having a predetermined luminance corresponding to the amount of current (input current) supplied from the first transistor T1.

The light emitting element LD may be an organic light emitting diode. The light emitting element LD may be an inorganic light emitting diode such as a micro light emitting diode (LED) or a quantum dot light emitting diode. The light emitting element LD may include a composite of an organic material and an inorganic material. FIG. 2 illustrates that the pixel PX includes a single light emitting element LD. The pixel PX may include light emitting elements LD connected in series, in parallel, or in series and parallel.

The light emitting element LD may deteriorate as usage time increases. As the light emitting element LD deteriorates, the voltage (or driving voltage) of the connected node Na may be higher than an initial voltage of the connected node Na. As the voltage of the connected node Na increases, the voltage stored in the storage capacitor Cst may decrease. The gate-source voltage of the first transistor T1 may decrease, and the amount of current supplied from the first transistor T1 to the light emitting element LD may decrease. That is, as the usage time of the display device increases, the amount of current supplied to the light emitting element LD may decrease.

Referring to FIG. 3, a current reduction ratio (%) with respect to usage time (hr) can be confirmed for each of different input grayscales. The current reduction ratio (%) may be a difference between the amount of current flowing through the light emitting element LD initially and the amount of current flowing through the light emitting element LD after a predetermined usage time has elapsed, expressed as a percentage (of the amount of current flowing through the light emitting element LD when the usage time is substantially 0 hours).

As the usage time increases, the current reduction ratio of the current flowing through the light emitting element LD may increase. That is, as the light emitting element LD deteriorates, the amount of current flowing through the light emitting element LD may decrease.

The current reduction ratio may vary according to the input grayscale. As the usage time increases, the current reduction ratio may increase as the input grayscale decreases. For example, the current reduction ratio when the input grayscale is 11 grayscales @11G may be greater than the current reduction ratio when the input grayscale is 31 grayscales @31G. The current reduction ratio when the input grayscale is 87 grayscales @87G may be greater than the current reduction ratio when the input grayscale is 127 grayscales @127G. The current reduction ratio of the light emitting element LD due to deterioration in a low grayscale may be greater than the current reduction ratio of the light emitting element LD due to deterioration in a high grayscale. The degree of deterioration of the light emitting element LD in consideration of the input grayscale may be determined, and the potential deviation of the data voltage may be compensated for.

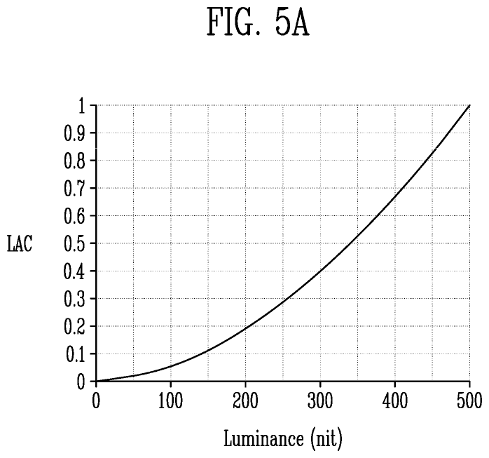

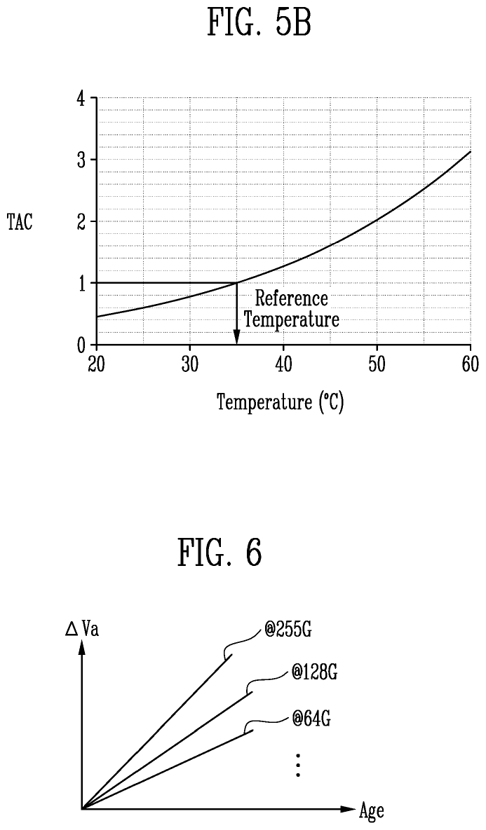

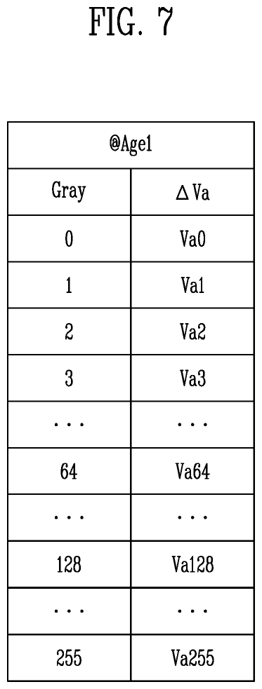

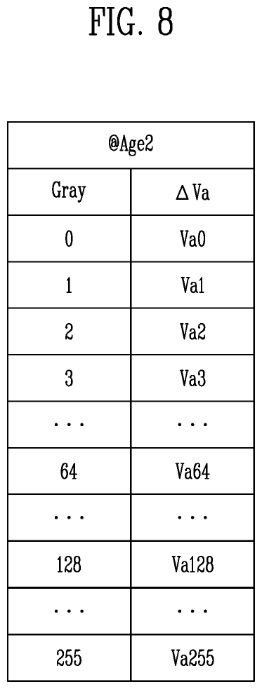

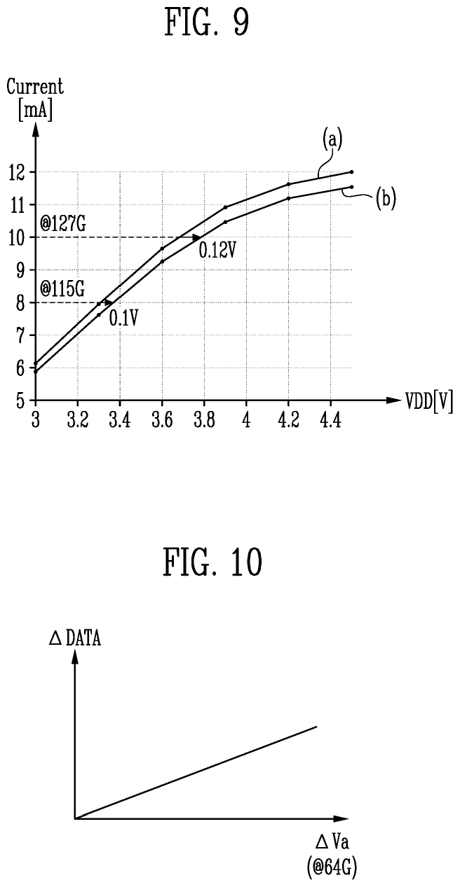

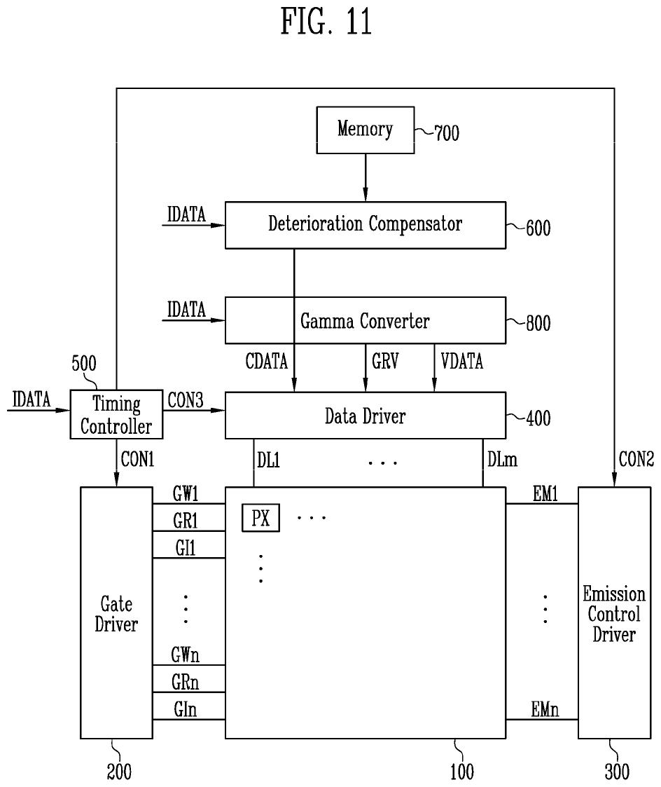

FIG. 4 is a block diagram illustrating a configuration of a deterioration compensator according to an embodiment. FIG. 5A is a graph illustrating a luminance acceleration coefficient according to an embodiment. FIG. 5B is a graph illustrating a temperature acceleration coefficient according to an embodiment. FIG. 6 is a graph illustrating a change amount of a driving voltage of a light emitting element with respect to a deterioration amount according to the input grayscale in the display device according to an embodiment. FIGS. 7 and 8 are diagrams illustrating lookup tables stored in a memory according to embodiments; the lookup tables specify the change amount of the driving voltage of the light emitting element with respect to the input grayscale at each deterioration amount. FIG. 9 is a graph illustrating a current value flowing through the light emitting element with respect to a first driving voltage in the display device according to an embodiment. FIG. 10 is a graph illustrating a relationship of a compensation amount with respect to the change amount of the driving voltage of the light emitting element in the display device according to an embodiment.

Referring to FIG. 4, the deterioration compensator 600 may include a deterioration accumulator 610, a change amount extractor 620, and a compensation data generator 630.

The deterioration accumulator 610 (or deterioration recorder 610) may store a deterioration amount Age (or a lifetime or usage time value) of the pixels PX (refer to FIG. 1) of the pixel unit 100 (refer to FIG. 1) in response to the input image data IDATA (or the input grayscale), and may update the deterioration amount Age as the usage time increases. The deterioration accumulator 610 may store the deterioration amount Age of the light emitting element LD (refer to FIG. 2) of each of the pixels PX (refer to FIG. 1). The deterioration amount Age stored by the deterioration accumulator 610 may be larger as the input grayscale is higher. The deterioration accumulator 610 may store the deterioration amount Age having a larger value as the accumulated image data increases and/or as the usage time increases.

The deterioration accumulator 610 may store the deterioration amount Age having a larger value as the temperature increases and/or as the luminance of a displayed image increases. The deterioration accumulator 610 may store the deterioration amount Age with reference to Equation 1 below.

$$Age = [ {( \frac{IG}{255} )}^{2.2} ] \times LAC \times TAC \qquad [ Equation 1 ]$$

In Equation 1, Age may represent the deterioration amount, IG may represent a grayscale value included in the input image data IDATA, LAC may represent a luminance acceleration coefficient, and TAC may represent a temperature acceleration coefficient.

Referring FIGS. 5A and 5B, the luminance acceleration coefficient LAC may have a larger value as the luminance corresponding to the input image data IDATA increases. For example, as shown in FIG. 5A, the luminance acceleration coefficient LAC may have a value of 0 at the lowest luminance (for example, 0 nit) and may have a value of 1 at the highest luminance (for example, 500 nit). Similarly, the temperature acceleration coefficient TAC may have a larger value as the temperature increases. As shown in FIG. 5B, the temperature acceleration coefficient TAC may have a value of 1 based on a reference temperature (for example, room temperature). The temperature acceleration coefficient TAC may have a value greater than 1 when the temperature is higher than the reference temperature, and the temperature acceleration coefficient TAC may have a value less than 1 when the temperature is lower than the reference temperature.

The change amount extractor 620 may receive the deterioration amount Age from the deterioration accumulator 610, and extract (or predict/determine) the change amount of the voltage of the connected node Na (refer to FIG. 2) of the pixel PX (or the driving voltage of the light emitting element) with respect to the deterioration amount Age. The change amount of the voltage of the connected node Na may be referred to as a change amount ΔVa of the driving voltage of light emitting element.

Referring to FIG. 6, the change amount ΔVa of the driving voltage of the light emitting element with respect to the deterioration amount Age can be confirmed. The change amount ΔVa of the driving voltage of the light emitting element may be a difference between the initial voltage of the connected node Na (refer to FIG. 2) and the voltage of the connected node Na after a predetermined usage time has elapsed (or according to the deterioration amount Age).

As the usage time increases, the change amount ΔVa of the driving voltage of the light emitting element may increase. As the light emitting element LD deteriorates, the voltage of the connected node Na may increase, and thus the change amount of the voltage of the connected node Na may increase.

The change amount ΔVa of the driving voltage of the light emitting element may vary according to the input grayscale. As the deterioration amount Age increases, the change amount ΔVa of the driving voltage of the light emitting element may increase as the input grayscale increases. For example, the change amount ΔVa of the driving voltage of the light emitting element when the input grayscale is 255 grayscales @255G may be greater than the change amount ΔVa of the driving voltage of the light emitting element when the input grayscale is 128 grayscales @128G. The change amount ΔVa of the driving voltage of the light emitting element when the input grayscale is 128 grayscales @128G may be greater than the change amount ΔVa of the driving voltage of the light emitting element when the input grayscale is 64 grayscales @64G. The change amount ΔVa of the driving voltage of the light emitting element due to deterioration in a high grayscale may be greater than the change amount ΔVa of the driving voltage of the light emitting element due to deterioration in a low grayscale.

The change amount ΔVa of the driving voltage of the light emitting element may be extracted when the first transistor T1 (described with reference to FIG. 2) is driven in the linear mode. Various methods may be applied to extract the change amount ΔVa of the driving voltage of the light emitting element.

As the first transistor T1 is driven in the linear mode, and as the usage time increases (or according to the deterioration amount Age), the change amount extractor 620 may extract the change amount ΔVa of the driving voltage of the light emitting element with respect to the input grayscale. The change amount ΔVa of the driving voltage of the light emitting element with respect to the input grayscale at each deterioration amount Age may be extracted from information stored in the memory 700.

Referring to FIGS. 7 and 8, which illustrate information stored in the memory 700, the change amount ΔVa of the driving voltage of the light emitting device with respect to the input grayscale in a first deterioration amount @Age1 and a second deterioration amount @Age2 can be confirmed.

The change amount ΔVa of the driving voltage of the light emitting element for each of 0 to 255 grayscales may be provided in a lookup table with respect to the first deterioration amount @Age1 and the second deterioration amount @Age2. For example, the change amount ΔVa of the driving voltage of the light emitting element in 0 grayscales may be set to Va0, and the change amount ΔVa of the driving voltage of the light emitting element in 64 grayscales may be set to Va64. Here, Va64 may correspond to a value greater than Va0. As the input grayscale increases, the change amount of the driving voltage of the light emitting element may increase. The change amounts ΔVa of the driving voltage of the light emitting element with respect to the input grayscales in the lookup table may be preset before the display device is shipped (and/or sold), and/or may be set when the display device is being used. The change amounts ΔVa of the driving voltage of the light emitting element of the lookup table with respect to the first deterioration amount @Age1 and the second deterioration amount @Age2 may be for identification, and may have different values according to the deterioration amounts @Age1 and @Age2.

With reference to FIG. 2, the change amount ΔVa of the driving voltage of the light emitting element with respect to the input grayscale in the lookup table may be set based on a relationship of the current output by driving the first transistor T1 in the linear mode and the change of the first driving voltage VDD.

Since the first transistor T1 is driven in the linear mode, the voltage of the connected node Na may be the same as the first driving voltage VDD. The change amount ΔVa of the driving voltage of the light emitting element may be determined from a change amount of the first driving voltage VDD.

Referring to FIG. 9, a current value flowing through the light emitting element LD according to the first driving voltage VDD may be confirmed. The current value flowing through the light emitting element LD may correspond to the input grayscale with respect to the pixel PX. As the current value increases, the input grayscale may correspond to a larger value. The graph indicated by (a) may correspond to the initial voltage of the connected node Na, and the graph indicated by (b) may correspond to the voltage of the connected node Na after deterioration.

For example, when the current value is 8 mA, the input grayscale may correspond to 115 grayscales; the change amount ΔVa of the driving voltage of the light emitting element may correspond to 0.1 V. When the current value is 10 mA, the input grayscale may correspond to 127 grayscales; the change amount ΔVa of the driving voltage of the light emitting element may correspond to 0.12 V. The change amount extractor 620 may extract the change amount ΔVa of the driving voltage of the light emitting element corresponding to the current value flowing through the light emitting element LD (when the first transistor T1 is driven in the linear mode). The change amount ΔVa of the driving voltage of the light emitting element provided in the lookup table of the memory 700 may be determined by recording the change amount of the first driving voltage VDD (or the change amount ΔVa of the driving voltage of the light emitting element) according to the current value (or the input grayscale) shown in FIG. 9.

Referring to FIG. 4, the compensation data generator 630 may receive the change amount ΔVa of the driving voltage of the light emitting element from the change amount extractor 620 and calculate the compensation amount based on the change amount ΔVa of the driving voltage of the light emitting element. The compensation data generator 630 may generate and output the compensation data CDATA (or adjusted data CDATA) based on the compensation amount. For example, the compensation data generator 630 may generate the compensation data CDATA by applying (for example, adding) the compensation amount to the input image data IDATA.

Referring to FIG. 10, a relationship of the compensation amount ΔDATA with respect to the change amount ΔVa of the driving voltage of the light emitting element can be confirmed. The change amount ΔVa of the driving voltage of the light emitting element with respect to each input grayscale may be proportional to the compensation amount ΔDATA (or adjustment amount ΔDATA). Accordingly, as the change amount ΔVa of the driving voltage of the light emitting element increases, the compensation amount ΔDATA may increase. FIG. 10 shows the relationship of the compensation amount ΔDATA with respect to the change amount ΔVa of the driving voltage of the light emitting element when the input grayscale is 64 grayscales @64G. The change amount ΔVa of the driving voltage of the light emitting element with respect to each of all the applicable input grayscales may be proportional to a compensation amount ΔDATA.

The compensation data generator 630 may receive the change amount ΔVa of the driving voltage of the light emitting element with respect to each input grayscale, and may calculate the compensation amount ΔDATA based on the capacitance of the storage capacitor Cst and the capacitance of the gate parasitic capacitor Cpa.

The compensation data generator 630 may calculate the compensation amount ΔDATA using Equation 2 below.

$$Δ DATA = Δ Va \times \frac{Cst}{Cst + Cpa} \qquad [ Equation 2 ]$$

In Equation 2, Cst may represent the capacitance of the storage capacitor, and Cpa may represent the capacitance of the gate parasitic capacitor. Cpa may be predetermined in a design process.

The compensation data generator 630 may generate the compensation data CDATA by applying the compensation amount ΔDATA to the input image data IDATA. For example, the compensation data generator 630 may generate the compensation data CDATA by adding the compensation amount ΔDATA to the input image data IDATA. The compensation data generator 630 may provide the compensation data CDATA to the data driver 400. The data driver 400 may convert the compensation data CDATA to generate the data voltage.

The display device may detect the change amount of the driving voltage of the light emitting element, which is changed as the usage time increases, and may adjust the data voltage to substantially prevent unwanted afterimages. Advantageously, the display quality of the display device may be satisfactory.

FIG. 11 is a block diagram illustrating a configuration of a display device according to an embodiment.

Referring to FIG. 11, the display device may include a pixel unit 100, a gate driver 200, an emission control driver 300, a data driver 400, a timing controller 500, a deterioration compensator 600, a memory 700, and a gamma converter 800. The display device shown in FIG. 11 may include elements and features that are similar to or identical to elements and features of the display device shown in FIG. 1.

The gamma converter 800 may perform gamma conversion on the input image data IDATA to generate gamma conversion data VDATA and provide the gamma conversion data VDATA to the data driver 400. The gamma converter 800 may perform gamma conversion on a grayscale value corresponding to at least one pixel PX of the pixel unit 100 included in the input image data IDATA, and may generate the gamma conversion data VDATA including a gamma conversion value. The gamma conversion data VDATA may correspond to a data voltage obtained by converting a grayscale domain into a voltage domain.

The pixel unit 100 may be divided into blocks each including pixels PX. The blocks may include the same number of pixels PX or different numbers of pixels PX. A block may be a control unit for the pixels PX, and may be specified in a memory before the display device is shipped and/or sold, and/or may be specified the display device is being used.

The gamma converter 800 may generate gamma voltages GRV having various voltage levels and may provide the gamma voltages GRV to the data driver 400. The gamma converter 800 may include a digital gamma voltage generator. The gamma converter 800 may generate linear gamma voltages GRV with respect to a digital input value.

The data driver 400 may generate the data voltage by converting the compensation data CDATA provided from the deterioration compensator 600 based on the gamma voltages GRV provided from the gamma converter 800.

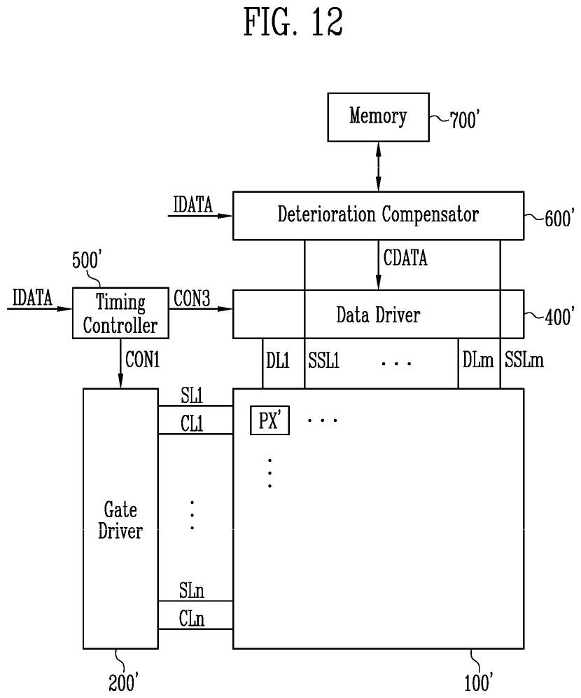

FIG. 12 is a block diagram illustrating a configuration of a display device according to an embodiment.

Referring to FIG. 12, the display device may include a pixel unit 100′, a gate driver 200′, a data driver 400′, a timing controller 500′, a deterioration compensator 600′, and a memory 700′. The display device shown in FIG. 12 may include elements and features that are similar to or identical to the display device shown in FIG. 1.

The pixel unit 100′ may include pixels PX′ for displaying an image. The pixel unit 100′ may include a pixel PX′ electrically connected to at least one of gate lines SL1 to SLn, at least one of control lines CL1 to CLn, at least one of data lines DL1 to DLm, and at least one of sensing lines SSL1 to SSLm.

The gate driver 200′ may provide a gate signal and a control signal to the pixels PX′ of the pixel unit 100′ through the gate lines SL1 to SLn and the control lines CL1 to CLn. FIG. 12 shows that the gate lines SL1 to SLn and the control lines CL1 to CLn are connected to one gate driver 200′. The gate lines SL1 to SLn and the control lines CL1 to CLn may be respectively connected to separate gate drivers 200′.

The data driver 400′ may provide a data voltage that is adjusted in response to the compensation amount to the pixels PX′ of the pixel unit 100′ through the data lines DL1 to DLm. The data driver 400′ may generate a data voltage by converting the compensation data CDATA in which the input image data IDATA is adjusted by the deterioration compensator 600′ and may provide the data voltage to the pixels PX′.

The timing controller 500′ may receive input image data IDATA from an external source, and may generate a gate control signal CON1 and a data control signal CON3. The timing controller 500′ may control the gate driver 200′ and the data driver 400′ by providing the gate control signal CON1 and the data control signal CON3 to the gate driver 200′ and the data driver 400′, respectively. The timing controller 500′ may further control the deterioration compensator 600′.

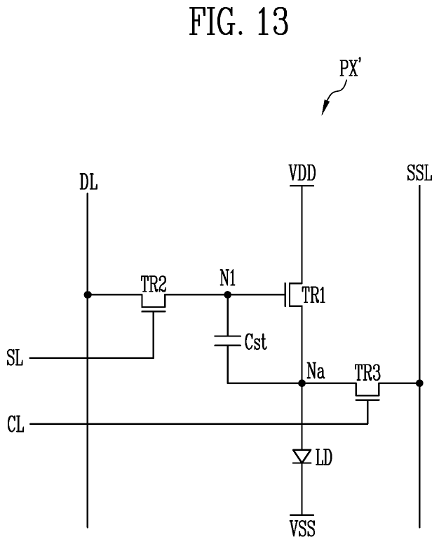

The deterioration compensator 600′ may update the deterioration amount Age (or the lifetime or usage time value) of the pixels PX′ of the pixel unit 100′ in response to the input image data IDATA (or the input grayscale), may sense/obtain the voltage of the connected node Na (refer to FIG. 13) of the pixel PX′ (or the driving voltage of the light emitting element) with respect to the deterioration amount Age to calculate the change amount ΔVa of the driving voltage of the light emitting element, and may calculate the compensation amount. The deterioration compensator 600′ may generate the compensation data CDATA based on the calculated compensation amount.

The memory 700′ may include a lookup table that stores the change amount ΔVa of the driving voltage of the light emitting element with respect to the input grayscale at each deterioration amount Age. The deterioration compensator 600′ may obtain a change amount ΔVa of the driving voltage of the light emitting element from the memory 700′ by providing an input grayscale and a deterioration amount Age to the memory 700′.

FIG. 13 is a circuit diagram illustrating a pixel included in FIG. 12 according to an embodiment.

Referring to FIG. 13, a pixel PX′ may include a light emitting element LD, a first transistor TR1 (or a driving transistor), a second transistor TR2, a third transistor TR3, and a storage capacitor Cst.

A first electrode of the first transistor TR1 may be connected to a first driving voltage VDD, and a second electrode of the first transistor TR1 may be connected to a connected node Na (or a first electrode of the light emitting element LD). A gate electrode of the first transistor TR1 may be connected to a first node N1. The first transistor TR1 may control the amount of current flowing through the light emitting element LD in response to a voltage of the first node N1.

A first electrode of the second transistor TR2 may be connected to a data line DL, and a second electrode of the second transistor TR2 may be connected to the first node N1. A gate electrode of the second transistor TR2 may be connected to a gate line SL. The second transistor TR2 may be turned on when a gate signal is supplied to the gate line SL to transfer a data signal (or a data voltage) from the data line DL to the first node N1.

The third transistor TR3 may be connected between a sensing line SSL and the second electrode of the first transistor TR1 (or the connected node Na). A first electrode of the third transistor TR3 may be connected to the sensing line SSL, and a second electrode of the third transistor TR3 may be connected to the connected node Na (or the second electrode of the first transistor TR1). A gate electrode of the third transistor TR3 may be connected to a control line CL. The third transistor TR3 may be turned on when a control signal is supplied to the control line CL to electrically connect the sensing line SSL and the connected node Na (or the second electrode of the first transistor TR1).

When the third transistor TR3 is turned on, an initialization voltage may be supplied to the connected node Na. In a sensing period, when the third transistor TR3 is turned on, a current generated by the first transistor TR1 may be supplied to the deterioration compensator 600′.

The storage capacitor Cst may be connected between the first node N1 and the connected node Na. The storage capacitor Cst may store a voltage corresponding to a voltage difference between the first node N1 and the connected node Na.

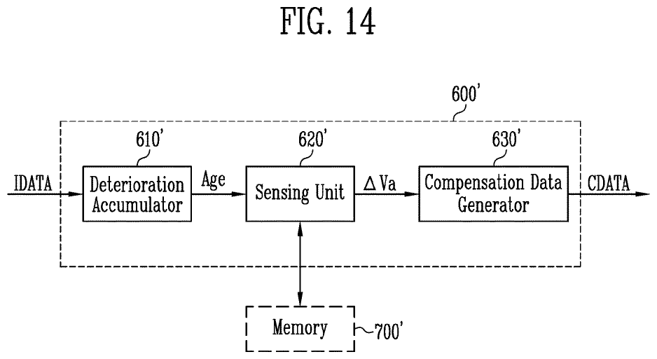

FIG. 14 is a block diagram illustrating a configuration of the deterioration compensator 600′ shown in FIG. 12 according to an embodiment.

Referring to FIG. 14, the deterioration compensator 600′ may include a deterioration accumulator 610′, a sensing unit 620′, and a compensation data generator 630′. Some elements and features of the deterioration compensator 600′ shown in FIG. 14 may be similar to or identical to some elements and features of the deterioration compensator 600 shown in FIG. 4.

The deterioration accumulator 610′ (or deterioration amount recorder 610′) may store the deterioration amount Age (or the lifetime or usage time value) of the pixels PX′ (refer to FIG. 12) of the pixel unit 100′ (refer to FIG. 12) in response to the input image data IDATA (or the input grayscale), and may update the deterioration amount Age according to the amount of the usage time. The deterioration accumulator 610′ may store the deterioration amount Age of the light emitting element LD (refer to FIG. 12) of each of the pixels PX′.

The sensing unit 620′ may receive the deterioration amount Age from the deterioration accumulator 610′, and may sense the voltage of the connected node Na of the pixel PX′ (or a driving voltage of the light emitting element) with respect to the deterioration amount Age. The sensing unit 620′ may sense the voltage of the connected node Na through the sensing line SSL when the third transistor TR3 described with reference to FIG. 13 is turned on.

The sensing unit 620′ may calculate the change amount ΔVa of the driving voltage of the light emitting element by comparing the sensed voltage of the connected node Na with the initial voltage of the connected node Na. The sensed voltage of the connected node Na may be a voltage according to the deterioration amount Age.

As the usage time increases, the change amount ΔVa of the driving voltage of the light emitting element may increase. As the light emitting element LD deteriorates, the voltage of the connected node Na may increase, so that the change amount of the voltage of the connected node Na may increase.

The change amount ΔVa of the driving voltage of the light emitting element may vary according to the input grayscale. As the deterioration amount Age increases, the change amount ΔVa of the driving voltage of the light emitting element may increase as the input grayscale increases. For example, referring to FIG. 6, the change amount ΔVa of the driving voltage of the light emitting element due to deterioration in a high grayscale may be greater than the change amount ΔVa of the driving voltage of the light emitting element due to deterioration in a low grayscale.

The sensing unit 620′ may update the calculated change amount ΔVa of the driving voltage of the light emitting element in the memory 700′.

The memory 700′ may receive and store the change amount ΔVa of the driving voltage of the light emitting element with respect to the input grayscale at each deterioration amount Age from the sensing unit 620′. For example, referring back to FIGS. 7 and 8, the change amount ΔVa of the driving voltage of the light emitting element with respect to the input grayscale at each deterioration amount Age may be updated in the lookup table.

The compensation data generator 630′ may receive the change amount ΔVa of the driving voltage of the light emitting element from the sensing unit 620′ and may calculate the compensation amount.

The change amount ΔVa of the driving voltage of the light emitting element with respect to each input grayscale may be proportional to the compensation amount. Accordingly, as the change amount ΔVa of the driving voltage of the light emitting element increases, the compensation amount may increase.

The compensation data generator 630′ may calculate the compensation amount using Equation 2 described above. In Equation 2, Cpa may represent a capacitance between the gate electrode of the first transistor TR1 of FIG. 13 and elements connected to the gate electrode of the first transistor TR1 of FIG. 13.

The compensation data generator 630′ may generate the compensation data CDATA (or adjusted data CDATA) based on the compensation amount. The compensation data generator 630′ may generate the compensation data CDATA by applying (for example, adding) the compensation amount to the input image data IDATA.

The compensation data generator 630′ may provide the compensation data CDATA to the data driver 400′. The data driver 400′ may convert the compensation data CDATA to generate a data voltage.

The display device may detect the change amount of the driving voltage of the light emitting element, which is changed as the usage time increases, and may adjust the data voltage to substantially prevent unwanted afterimages. Advantageously, the display quality of the display device may be satisfactory.

Examples of embodiments have been disclosed through the detailed description and the drawings. Various modifications and changes to the disclosed embodiments are possible without departing from the scope specified by the claims.

What is claimed is:

1. A display device comprising:
a pixel including a light emitting element;
a deterioration compensator recording a deterioration amount of the pixel in response to an input grayscale, determining a change amount of a driving voltage of the light emitting element based on the deterioration amount and the input grayscale, and generating adjusted data by calculating an adjustment amount based on the change amount of the driving voltage of the light emitting element; and
a data driver supplying a data voltage corresponding to the adjusted data to the pixel,
wherein the change amount of the driving voltage of the light emitting element varies according to the input grayscale.

2. The display device of claim 1, wherein the change amount of the driving voltage of the light emitting element increases as the input grayscale increases.

3. The display device of claim 1, wherein the change amount of the driving voltage of the light emitting element increases as the deterioration amount increases.

4. The display device of claim 1, further comprising:
a data line;
a first gate line; and
a second gate line,
wherein the pixel further includes:
a first node;
a second node;
a connected node;
a first transistor including a first electrode receiving a first driving voltage through the first node, a second electrode electrically connected to the connected node, and a gate electrode electrically connected to the second node;
a second transistor including a first electrode electrically connected to the data line, a second electrode electrically connected to the second node, and a gate electrode electrically connected to the first gate line;
a third transistor including a first electrode receiving a reference voltage, a second electrode electrically connected to the second node, and a gate electrode electrically connected to the second gate line; and
a storage capacitor including a first electrode electrically connected to the second node and including a second electrode electrically connected to the connected node, and
wherein the light emitting element includes a first electrode electrically connected to the connected node and includes a second electrode receiving a second driving voltage different from the first driving voltage.

5. The display device of claim 4, wherein the change amount of the driving voltage of the light emitting element is a difference between an initial voltage of the connected node and a voltage of the connected node according to the deterioration amount.

6. The display device of claim 5, wherein the deterioration compensator causes the first transistor to operate in a linear mode and determines the change amount of the driving voltage of the light emitting element based on a current value of the light emitting element as the first driving voltage is changed.

7. The display device of claim 6, wherein the first transistor outputs the first driving voltage to the connected node when operating in the linear mode.

8. The display device of claim 4, further comprising:
a third gate line; and
an emission control line,
wherein the pixel further includes:
a fourth transistor including a first electrode electrically connected to the connected node, a second electrode receiving an initialization voltage, and a gate electrode electrically connected to the third gate line; and
a fifth transistor including a first electrode receiving the first driving voltage, a second electrode electrically connected to the first node, and a gate electrode electrically connected to the emission control line.

9. The display device of claim 8, wherein the deterioration compensator causes the first transistor to operate in a linear mode and determines the change amount of the driving voltage of the light emitting element based on a current value of the light emitting element as the first driving voltage is changed.

10. The display device of claim 9, wherein the first transistor outputs the first driving voltage to the connected node when operating in the linear mode.

11. The display device of claim 1, further comprising:
a memory including a lookup table that specifies values of the change amount of the driving voltage of the light emitting element corresponding to values of the input grayscale and values of the deterioration amount.

12. The display device of claim 11, wherein the deterioration compensator receives information specified in the lookup table from the memory and calculates the adjustment amount based on the change amount of the driving voltage of the light emitting element.

13. The display device of claim 1, wherein the deterioration compensator stores an increased value of the deterioration amount as at least one of a temperature of the display device and a luminance of an image displayed by the display device increases.

14. A display device comprising:
a pixel including a light emitting element;
a deterioration compensator recording a deterioration amount of the pixel in response to an input grayscale, determining a change amount of a driving voltage of the light emitting element based on the deterioration amount and the input grayscale, and generating adjusted data by calculating an adjustment amount based on the change amount of the driving voltage of the light emitting element; and
a data driver supplying a data voltage corresponding to the adjusted data to the pixels,
wherein the deterioration compensator senses the driving voltage of the light emitting element to determine the change amount of the driving voltage of the light emitting element, and
wherein the change amount of the driving voltage of the light emitting element varies according to the input grayscale.

15. The display device of claim 14, wherein the change amount of the driving voltage of the light emitting element increases as the input grayscale increases.

16. The display device of claim 14, wherein the change amount of the driving voltage of the light emitting element increases as the deterioration amount increases.

17. The display device of claim 14, further comprising:
a data line;
a gate line;
a sensing line; and
a control line,
wherein the pixel further includes:
a first node;
a connected node;
a first transistor including a first electrode receiving a first driving voltage, a second electrode electrically connected to the connected node, and a gate electrode electrically connected to the first node;
a second transistor including a first electrode electrically connected to the data line, a second electrode electrically connected to the first node, and a gate electrode electrically connected to the gate line;
a third transistor including a first electrode electrically connected to the sensing line, a second electrode electrically connected to the connected node, and a gate electrode electrically connected to the control line; and
a storage capacitor including a first electrode electrically connected to the first node and including a second electrode electrically connected to the connected node, and
wherein the light emitting element includes a first electrode electrically connected to the connected node and includes a second electrode receiving a second driving voltage different from the first driving voltage.

18. The display device of claim 17, wherein the driving voltage of the light emitting element is a voltage of the connected node, and
wherein the deterioration compensator senses the voltage of the connected node.

19. The display device of claim 14, further comprising:
a memory including a lookup table that specifies values of the change amount of the driving voltage of the light emitting element corresponding to values of the input grayscale and values of the deterioration amount.

20. The display device of claim 19, wherein the memory receives the change amount of the driving voltage of the light emitting element from the deterioration compensator.
